(19) United States
(12) Patent Application Publication
(10) Pub. No.: US 2025/0245260 A1
(43) Pub. Date: Jul. 31, 2025

(54) SYSTEMS AND METHODS TO ACCELERATE CREATION OF AND/OR SEARCHING FOR DIGITAL TWINS ON A COMPUTERIZED PLATFORM

(71) Applicant: ORANGE, ISSY-LES-MOULINEAUX (FR)

(72) Inventors: Wu SI, Beijing (CN); Yuexian LI, Beijing (CN); Chuantao YIN, Beijing (CN)

(21) Appl. No.: 18/856,373

(22) PCT Filed: Apr. 11, 2023
(86) PCT No.: PCT/IB2023/000212

§ 371 Date: Oct. 11, 2024

(30) Foreign Application Priority Data
Apr. 12, 2022 (WO) PCT/CN2022/086356

(51) Int. Cl. G06F 16/36; G06F 40/30; G06N 3/045

(52) U.S. Cl. CPC G06F 16/367; G06F 40/30; G06N 3/045

(57) ABSTRACT

To accelerate creation of and/or searching for digital twins on a computerized platform, the described systems and computer-implemented methods leverage information regarding a sequence of digital-twin ontologies corresponding to user input to the system, in order to predict the next digital-twin ontology that follows on from the sequence. The method generates, for each of the sequence of ontologies corresponding to the user input, a composite embedding that combines a graph embedding and a semantic embedding of this ontology. A representative embedding is generated to characterize the composite embeddings of the overall sequence and this representative embedding is compared to composite embeddings of candidate ontologies defined on the computerized platform. The method outputs, as the prediction of the next ontology following on from the user's sequence, one or more selected candidate digital-twin ontologies that are similar to the representative embedding of the user's sequence.

### FIELD OF THE INVENTION

The present invention relates to systems and methods to accelerate creation of and/or searching for digital twins on a computerized platform. More particularly, the invention relates to systems and methods that anticipate the next digital-twin ontology following on from a sequence corresponding to user input, notably user input while creating digital twins or searching for digital twins.

### TECHNICAL BACKGROUND

As technology develops, increasing numbers and types of real-world objects and environments are being represented in digital form on computerized platforms, as so-called “digital twins” (also called avatars). A digital twin is a virtual model designed to accurately reflect a physical object and, typically, may be included in a wider model representing its environment, other objects and relationships between objects. For example, in such a wider model the digital twin Car_1 can park in the digital twin Car Park_A, or the digital twin Room_1 may be in the digital twin Building_B.

As another example, a digital representation may be created of a manufacturing facility, or an office, and this representation of the facility/office may include digital twins representing different rooms in the facility/office, and different machines and objects within the rooms. The digital representation of the facility/office may include data regarding the specifications and current status of the machines and objects, and may provide access to data generated by the machines, and may provide management capabilities allowing remote control of the machines/objects.

A huge number of digital twins have been created on digital twin platforms, notably to represent Internet-of-Things (IoT) objects in the real world. More formally, digital twins are instances created based on ontologies, that is, based on class definitions that specify some class or properties applicable to the ontology in question. For example, Car_1 may be a specific instance of the ontology “car”.

Computerized platforms that maintain a digital representation of real-world objects (devices, environments) have also been developed to facilitate the administering, discovering and exploiting of IoT devices. As an example, there can be mentioned the “Thing in the future” platform (hereafter Thing'in) developed and maintained by Orange.

“Thing'in” platform establishes and maintains a graph of things which, like a social network providing similar functionality for people, is composed of physical things and entities (the nodes) and logs the relationships (the links) between them. Digital twins on this platform are digital representations of things. A core aspect of the platform is the indexation of real-world devices and objects, along with their descriptions, according to the defined ontologies recognized by the computerized platform in question. “Thing'in” platform maintains a structural and semantic definition not only of the IoT devices (connected objects) themselves and their relationships, but also of the ontologies that may be specified for the different objects, and the environments in which the connected objects are located. The environment may include objects that may not, themselves, be IoT devices but which are described by ontologies included in the “Thing'In” dataset (e.g., fountain, car park).

The “Thing'in” platform is equipped to support expansion by addition of new objects/devices. “Thing'in” platform is a multi-interface platform which engineers and IoT app developers can connect to and interact with at its front end, and data providers can do so at its back end. Thus, the number of objects logged on the platform evolves over time. The platform has respective APIs that allow data providers to insert objects, and that allow engineers and IoT app developers to connect to and interact with logged objects.

When an engineer creates a digital twin on a computerized platform, in principle they could manually specify all of the properties and/or classes applicable to the real-world object in question ab initio. However, this would be extremely time-consuming. Moreover, each digital twin would then be a kind of sui generis object and this would complicate searching for digital twins and management of digital twins on the computerized platform. So, it is more usual for engineers to specify properties of their digital twin by listing one or more of the ontologies that are already recognized by the computerized platform in question and which apply to the object in question. Thus, for example, if the engineer is creating a digital twin to represent an IoT object which is a particular traffic light (e.g. the northmost traffic light at the intersection of the rue de l'Université and of the boulevard de la Tour Maubourg in Paris), and the computerized platform on which the digital twin is to be managed recognizes an ontology “light” and an ontology “street furniture”, the engineer might specify that both of these ontologies apply to the digital twin that the engineer is creating. In other words, this digital twin represents an instance of the ontology “light” and an instance of the ontology “street furniture”.

Often an engineer interacting with a computerized IoT-management system creates a series of digital twins during a given session of activity on the system. For instance, an engineer may wish to create digital twins for components in a vehicle and, if they are working in a systematic manner, they may successively create digital twins for wheel 1, wheel 2, wheel 3 then wheel 4 of the vehicle, followed by brake 1, brake 2, and so on. The present inventors have realized that such processes of creating digital twins on a computerized platform may be accelerated, notably by leveraging information regarding the sequence of digital-twin ontologies that corresponds to the user input, in order to predict and notify the user about the next ontology that the user may require. More particularly, there may be some relationship between the ontologies that are instantiated by the series of digital twins being created, and it may thus be possible to predict candidate ontologies that the engineer may wish to use next. The creation of the required digital twins on the platform could be speeded up by transmitting to the engineer (e.g., via a user interface, display screen, etc.) a list of candidate ontologies that are predicted as likely to be needed next (e.g., seat, headlight, etc.).

Similarly, often users perform sequence of searches on a computerized platform such as “Thing'in” platform. For instance, an engineer or application developer seeking to locate IoT devices capable of supplying particular types of measurement data may search in the dataset maintained by the platform for IoT objects that correspond to a particular ontology (i.e., that are in a particular class, or have particular data properties or object properties). Once again, if the engineer requires multiple types of data, and is searching in a systematic manner, there may be a relationship between the sequence of ontologies specified in the search queries. The present inventors have realized that such processes of searching for digital twins on a computerized platform may be accelerated by leveraging information regarding the sequence of digital-twin ontologies specified in the user input, in order to predict and notify the user about the next ontology that the user may require for sue in the next search query.

In various technical fields, proposals have already been made to exploit a sequence of interactions that a user makes in order to predict some candidate item to notify to the user next. One approach consists in making use of a Markov chain model to predict the next item that may be relevant to the user, based on observation of the user's behaviour and/or based on items involved in the user's recent interactions. Another known approach consists in making use of supervised learning, for instance using a deep interest network (DIN), to predict an item to notify to a user based on a sequence of user interactions with a computerized system. DIN-based prediction systems employ a local-activation mechanism to focus on different characteristics of the user's interactions.

However, sequential predictor systems and prediction systems based on Markov chain models tend to fail in cases where information is sparse regarding multiple past sequences of user interactions on the platform in question.

Accordingly, a need exists for improved digital-twin-ontology-oriented search, prediction and/or recommendation systems and methods which improve the probability of obtaining a satisfactory number, variety and/or relevance in predictions of the next ontology following on from a sequence of ontologies corresponding to user input.

The present invention has been made in the light of the above issues.

### SUMMARY OF THE INVENTION

The present invention provides a computer-implemented method of predicting for a user, from a sequence of digital-twin ontologies corresponding to input by the user to a computerized platform, the next digital-twin ontology following said sequence, the method comprising:
generating a composite embedding of each of the digital-twin ontologies in said sequence, wherein the composite embedding combines a semantic embedding and a graph embedding of said digital-twin ontology;
determining, for said sequence of digital twin ontologies, a representative embedding characterizing the composite embeddings of the ontologies of the sequence;
comparing the representative embedding of the sequence with respective composite embeddings of each of a plurality of candidate ontologies defined on said computerized platform, to determine the degree of similarity between the representative embedding of the sequence and each of the composite embeddings of the candidate ontologies; and
outputting, to the user, as a prediction of the next digital-twin ontology following on from said sequence, information identifying a selected one or more of the candidate ontologies determined, by the comparing, to have a composite embedding similar to the representative embedding of the user's sequence.

This method provides the user with an indication of the next ontology that follows on from the sequence of ontologies that corresponds to their input. Depending on the application, this may constitute, for instance, a recommendation of the next ontology to use when creating a sequence of digital twins, or a recommendation of the next ontology to include in a search query, etc. The user may simply be informed of the prediction/recommendation, or automatic action may be taken, for instance to automatically pre-create a digital twin which is an instance of the predicted/recommended next ontology, or to automatically populate a field in a form defining a search query, and so on. Thus, the invention further provides methods and systems to automatically generate a digital twin instantiating the next ontology that follows on from a sequence corresponding to user input, with that “next ontology” being predicted according to the method above. Similarly, the invention still further provides methods and systems to automatically generate a search query including, as a search term, the next ontology that follows on from a sequence corresponding to user input, with that “next ontology” being predicted according to the method above.

Embodiments of prediction/recommendation methods according to the invention can enable the process of creating and/or searching for digital twins on a computerized platform to be accelerated, by notifying the user of a selection of predictions of the next digital-twin ontology that follows on from a sequence embodied in the user's input to the platform. The prediction can be generated even in the absence of a significant quantity of historical data regarding past sequences of ontologies corresponding to input by this user, or by other users.

In the above-mentioned method, the representative embedding of the user's sequence may be generated by determining an exponential weighted average of the composite embeddings of the ontologies of the sequence. In this manner extra weight can be given to the ontology or ontologies of the user's most recent input. Some embodiments use a first method in which the exponential weighted average of the composite embeddings of the ontologies of the sequence is determined according to the following formula:

$${( {E}_{user} )}_{n} = \{ \begin{matrix}{E}^{n} , & n = 0 \\ β * {( {E}_{user} )}_{n - 1} + ( 1 - β ) * {E}^{n} , & n > 0\end{matrix}$$

where (Eᵤₛₑᵣ)ₙ is the representative embedding determined for a sequence of n ontologies, Eⁿ is the composite embedding of the ontology ONTn in the sequence, and B is a momentum coefficient which ranges from 0 to 1. This first method provides good balance over the whole of the considered sequence. In some embodiments a second method is used in which the exponential weighted average of the composite embeddings of the ontologies of the sequence is determined according to the following formula:

$${( {E}_{user} )}_{n} = {\sum }_{t = 0}^{n} {W}_{t} * {E}^{t}$$

where (Eᵤₛₑᵣ)ₙ is the representative embedding determined for a sequence of n ontologies, E^{t} is the composite embedding of the ontology ONTₜ in the sequence, and Wt is a weight applied to the composite embedding of the ontology ONTₜ, said weights being determined according to the formula:

$${W}_{t} = \{ \begin{matrix}α , & t = 0 \\ β , & t = 1 \\ α * {W}_{t - 2} + β * {W}_{t - 1} , & t > 1\end{matrix}$$

This second method focuses more heavily on the ontology or ontologies corresponding to the most recent user input.

In the above-mentioned method, the generating of a composite embedding of an ontology may comprise concatenating said semantic embedding and said graph embedding of the ontology. In certain embodiments of the invention the graph embedding is generated using a graph neural network implementing a node2vec model, node2vec being described in “node2vec: Scalable feature learning for networks” by S. He, K. Liu, G. Ji, and J. Zhao, A. Grover and J. Leskovec, in Proceedings of the 22nd ACM SIGKDD international conference on Knowledge discovery and data mining, 2016, pp. 855-864, the whole contents of which are incorporated herein by reference. Experiments have shown that use of the node2vec model provides good graph-embedding performance. In certain embodiments of the invention the semantic embedding is generated using an SBERT network to generate a semantic embedding of textual information characterizing the ontology, the SBERT network architecture being described in “Sentence-BERT: Sentence Embeddings using Siamese BERT-Networks” by Nils Reimers and Iryna Gurevych (arXiv:1908.10084), 2019, the entire contents of which are hereby incorporated herein by reference.

The above-mentioned method may include a step of assigning a rank score to the candidate ontologies based on the similarity of their composite embeddings to the representative embedding of the sequence, and selecting for outputting one or more of the ontologies having the highest rank score. The metric used to quantify similarity may be cosine similarity.

The above-mentioned method may include a preliminary step of determining the sequence of ontologies from a sequence of digital twins identified by the user input. In other words, the method can cater for the case where the user's input does not explicitly identify the ontologies in question but, rather, identifies digital twin that instantiate various ontologies.

The above-mentioned method may include a step of automatically creating, on the computerized platform, a digital twin instantiating a candidate ontology selected to be identified in the outputting. In this case the process of creating digital twins on the computerized platform may be further accelerated.

The present invention still further provides a recommendation system configured to predict for a user, from a sequence of digital-twin ontologies corresponding to input by the user to a computerized platform, the next digital-twin ontology following said sequence, the system comprising a computing apparatus programmed to execute instructions to perform any of the above-described prediction/recommendation methods.

The present invention still further provides a computer program comprising instructions which, when the program is executed by a processing unit of a computing apparatus, cause said processing unit to perform any of the above-described methods.

The present invention yet further provides a computer-readable medium comprising instructions which, when executed by a processor of a computing apparatus, cause the processor to perform any of the above-described prediction/recommendation methods.

The techniques of the present invention may be applied to predict/recommend digital-twin ontologies defined on a computerized digital-twin management platform. As an example, such methods and systems may be used to predict/recommend digital twin ontologies on the Thing'in platform.

### BRIEF DESCRIPTION OF THE DRAWINGS

Further features and advantages of the present invention will become apparent from the following description of certain embodiments thereof, given by way of illustration only, not limitation, with reference to the accompanying drawings in which:

FIG. 1 is a flow diagram illustrating a computer-implemented method, according to a first embodiment of the invention, to predict the next digital-twin ontology following on from a sequence of ontologies corresponding to user input;

FIG. 2 is a diagram that illustrates schematically the main modules in a system to implement the method of FIG. 1;

FIG. 3 is a diagram that illustrates schematically the main modules in an example implementation of an encoder in the system of FIG. 2;

FIG. 4 is a diagram that illustrates schematically the main modules in another example implementation of the encoder in the system of FIG. 2;

FIG. 5 shows images representing the results of graph embedding processes performed by neural network architectures based on four different types of model, in which:

FIG. 5(a) shows results obtained using a deepwalk model,

FIG. 5(b) shows results obtained using a node2vec model,

FIG. 5(c) shows results obtained using a LINE model, and

FIG. 5(d) shows results obtained using a struc2vec model; and

FIG. 6 is a diagram illustrating schematically the processing performed in an example implementation of the system of FIG. 2.

### DETAILED DESCRIPTION OF EXAMPLE EMBODIMENTS

The present invention provides embodiments of digital-twin-ontology-oriented search, prediction and/or recommendation systems, and corresponding computer-implemented methods, notably for datasets of digital-twins representing IoT objects, that enhance relevance, number and/or variety of retrieved digital twin ontologies by making use of a combination of graph embedding and semantic embedding.

The entities having digital twins in the IoT dataset may correspond to “things” in the IoT (e.g., specific instances of network-enabled devices, including, for instance, specific smart doorbells, smart vehicles, voice-control communication devices, etc.), as well as other real-world spaces (rooms, buildings), objects and the like in the environment of the IoT devices. The user interacting with the IoT platform may be a human (e.g., an engineer or application-developer), but the invention is not limited to this example and is applicable to input sequences generated by non-human agents, for example, bots and software applications. Typically, the input is received from a remote user over a wired or wireless network connection, or from a local user using a local user interface, but the invention is not limited in regard to the manner by which the user input is formulated/arrives at the ontology-prediction system.

The digital twins in a dataset are instances of ontologies which tend to have a hierarchical structure comprising parent-child relationships between ontologies at different levels in the hierarchy. The ontologies themselves may be considered to form a graph in which each ontology is a vertex and the parent-child relationship between a pair of ontologies represents an edge in the graph. So, it may be considered that a dataset which represents IoT objects and their relationships, such as that of Thing'in platform, embodies an IoT-ontology graph. Considering the Thing'in platform, it may be considered that:
each of the classes, data properties and object properties recognized by the platform constitutes a respective ontology that may be associated with an IoT object or other entity registered on the platform,
that the classes, data properties and object properties are vertices of a graph, and
the relationships between the classes, data properties and object properties are edges in the graph.

Typically, each digital-twin ontology in the IoT dataset is described by a plurality of fields, including at least one field that lists semantic information. For example, on the “Thing'in” platform, each ontology (i.e., each class, data-property and object-property) has a name, and optionally there may also be a textual description, and associated comments.

Embodiments of the present invention generate and exploit a new kind of composite representation of the ontologies under consideration. The composite representation, E_{COMP}, which may be considered to be an encoding of the ontology in question, or a composite embedding thereof, combines a graph embedding, E_{GR}, and a semantic embedding, E_{SEM}, of the ontology in question, (recalling that in the field of deep learning/neural networks, an embedding is a representation in a relatively low-dimensional space of a relatively high-dimensional vector). In order to predict one or more ontologies to notify to a user as the “next” ontology following on from an input sequence, methods and systems according to the invention look for candidate ontologies whose composite embedding is similar to a representative embedding generated to represent the sequence of ontologies last input by the user.

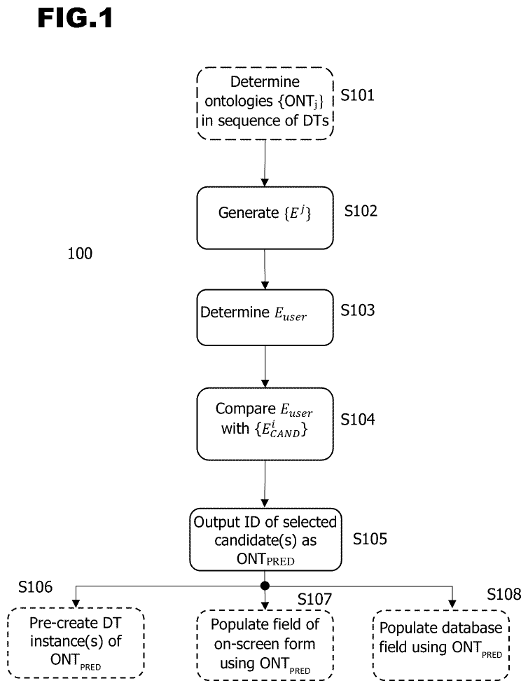

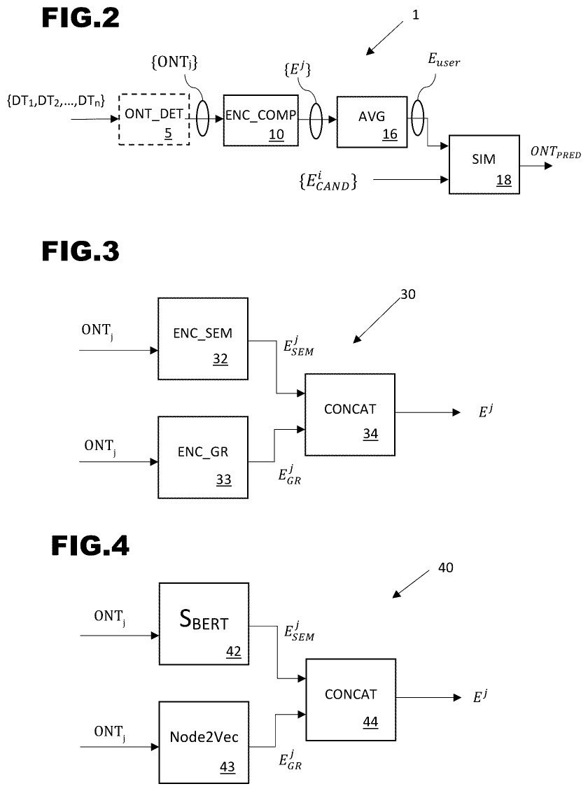

A computer-implemented method 100 according to a first embodiment of the invention will now be described with reference to FIG. 1, and corresponding systems to implement the method will be described with reference to FIGS. 2-5.

In the examples discussed below in relation to FIGS. 1 to 5, the digital twins are IoT entities in a dataset such as the whole or a subset of a database of an IoT platform and the digital-twin ontologies are the classes, object-properties and data-properties of defined on the IoT platform (which may be Thing'in or another computerized platform). However, it is to be understood that the invention is applicable more generally to systems and methods that search/recommend digital-twin ontologies irrespective of whether the digital twins represent IoT entities. Thus, the methods and systems of the invention may be applied to computerized digital-twin platforms in general.

First, an outline will be given of the main steps in the search/recommendation method 100 according to the first embodiment, then each step will be discussed in greater detail. The method begins with processing of a sequence of ontologies input to a computerized system by a user. The sequence of ontologies may correspond to explicit input by the user, for example in a case where the user makes a sequence of searches for digital twins which instantiate a respective sequence of ontologies (i.e., each search in the sequence identifies an ontology and the user seeks to discover objects on the platform that correspond to the ontology in question). However, the present invention is not limited to the case where the processed sequence of digital-twin ontologies corresponds to user-input which identifies ontologies per se. Thus, for example, the sequence of ontologies processed by embodiments of the invention may be determined, in a step S101, from user-input which identifies a sequence of digital twins, notably a sequence of digital twins that the user creates on the computerized system. In the latter case, the ontology ONTⱼ instantiated by each digital twin DTⱼ typically is determined by look-up of the class, data properties and object properties of the digital twin in question as input by the user and/or as recorded in the computerized system.

In a step S102 of method 100, a representation E^{j} is generated of each digital-twin ontology included in the sequence derived from the user input. As mentioned above, this representation E^{j} is a composite embedding that combines a graph embedding E_{GR}^{j} and a semantic embedding E_{SEM}^{j} of the ontology ONTⱼ in question. The manner in which the graph embedding and semantic embedding are generated is discussed below. Typically, the input sequence to be processed corresponds to all of the ontologies involved in user input during the current communication session between the user and the digital-twin platform in question. However, in certain embodiments, if the same user has been involved in a plurality of communications sessions with the digital-twin platform, the processed sequence of ontologies may include ontologies involved in user input during sessions prior to the current session.

In step S103 of method 100, a representative embedding, Eᵤₛₑᵣ, is generated to characterize the overall sequence of ontologies, and this representative embedding Eᵤₛₑᵣ is then compared (step S104) with composite embeddings {E_{CAND}ⁱ} of a set of one or more candidate ontologies ONTᵢ from the dataset of the computerized digital-twin platform in question. Data is then output (step S105) identifying one or more selected ones of the candidate ontologies, for instance, the one or more candidate ontologies which are most similar to the representative embedding Eᵤₛₑᵣ which characterizes the overall sequence of user-input digital-twin ontologies. The one or more ontologies ONT_{PRED} identified in the output data may be considered to be predictions of the next ontology in the sequence corresponding to the user's latest interactions with the digital-twin platform.

The selected candidate ontologies for notification to the user may be output in any desired manner, notably, these results may be returned to a remote user by sending a message over the relevant wired or wireless connection, they may be provided to a local user by any suitable means (e.g., printing out, display on a screen), etc. The output results may be employed by the user in various ways, depending on the use case. For example, if the user input corresponds to creation of a series of digital twins on the computerized platform, and a list of one or more predictions of the “next ontology” is displayed to the user via a graphical user interface, the user may interact with the interface to select one of the predictions as the ontology of a digital twin to be created. As another example, if the user input corresponds to a series of searches on the computerized platform, and a list of one or more predictions of the “next ontology” is displayed to the user via a graphical user interface, the user may interact with the interface to select one of the predictions for inclusion in a search query to be submitted to the computerized platform.

The prediction/recommendation method according to the first embodiment of the invention, illustrated by the example in FIG. 1, helps to accelerate creation of and/or searching for digital twin on a computerized platform by generating a set of numerous and varied predictions of the next digital-twin ontology that follows on from a sequence of digital-twin ontologies corresponding to user input.

Certain embodiments of the method according to invention end with step S105 making an output to the user of one or more predictions ONT_{PRED} of the next ontology in the sequence. However, in other embodiments of the method there are additional steps which further accelerate the process of creating digital twins on a digital-twin platform and/or the process of searching for digital twins on such a platform. Thus, for example, certain embodiments of the method include a step S106 of automatic pre-creation of a digital twin which is an instance of a predicted next ontology ONT_{PRED} in the sequence. The user may then customize the pre-created digital twin, for instance by adjusting the data-properties or the like if needed, according to their requirements. In the case where a user is creating a series of digital twins on a computerized digital-twin platform, this automatic pre-creation of the next digital twin will tend to speed up the process of generating the digital twins on the platform.

In certain embodiments of the invention, a step S107 may be included of automatically populating a field of an on-screen form with data characterizing the predicted next ontology in the sequence. Such an on-screen form may, for example, constitute a search form enabling a user to define properties of digital twins they are searching for in the dataset.

In certain embodiments of the invention, a step S108 may be included of automatically populating a field of a database of the computerized digital-twin platform.

The methods described above are conveniently put into practice as computer-implemented methods. Thus, systems according to the present invention may be implemented on a general-purpose computer or device having computing capabilities, by suitable programming of the computer. In several applications the search systems according to the invention make comprise servers of IoT platforms, such as one or more servers supporting Orange's Thing'in platform.

Accordingly, the present invention provides a computer program containing instructions which, when executed on computing apparatus, cause the apparatus to perform the method steps of one or more of the methods described above.

The present invention further provides a non-transitory computer-readable medium storing instructions that, when executed by a computer, cause the computer to perform the method steps of one or more of the methods described above.

Next a description will be given of example embodiments of systems configured to implement the methods according to the invention, with reference to FIG. 2. It will be understood that such systems may be embodied in suitably-programmed computers. In other words, the systems described below may comprise one or more processors programmed to implement the functionality of the modules illustrated in FIGS. 2-5, with storage, memory and peripherals as required. Moreover, the one or more processors may be distributed between different servers and client devices, depending on the application.

FIG. 2 illustrates schematically the main functional modules of a system 1 according to an example embodiment of the invention. As shown in FIG. 2, the system 1 includes an encoder 10, ENC_COMP, which generates a composite embedding E^{j} of each ontology of the sequence corresponding to the user input. In some applications the system 1 includes an ontology-detection module 5 which, in the case where the user's input defines a sequence of digital twins, DT₁, DT₂, . . . , DTₙ, determines the set of ontologies {ONT^{j}} instantiated by this sequence of digital twins and supplies the sequence of ontologies to the encoder 10.

The system 1 further comprises a module 16, AVG, which processes the composite embeddings E^{j} of the ontologies corresponding to the user input and generates a representative embedding Eᵤₛₑᵣ that is characteristic of the overall sequence of ontologies. The system 1 also includes a comparison module 18, SIM, which determines the degree of similarity between the representative embedding Eᵤₛₑᵣ and each of a set {E_{CAND}ⁱ} of one or more composite embeddings of candidate ontologies defined in the target dataset. The comparison module 18 outputs one or more predictions ONT_{PRED} of the next ontology in the sequence corresponding to the user input.

As explained above, the encoder 10 is configured to generate, in respect of an ontology ONTⱼ, a composite embedding E^{j} which combines a graph embedding and a semantic embedding of the ontology in question. FIG. 3 illustrates schematically an example implementation 30 of the encoder 10.

As shown in FIG. 3, a first encoder 32, ENC_SEM, generates a semantic embedding of the ontology ONTⱼ, Suppose the input sequence is: (ontology₁, ontology₂, . . . , ontologyₙ), where ontology; is the ontology of the j'th entity the user has created, and n is the considered sequence length. The semantic encoder 32 may generate a semantic embedding of ONTj based on textual information Ont_{text_information}, associated with this ontology. Such textual information may include, by way of non-limiting example, one or more of the name, description and comments associated with the ontology in the digital-twin platform in question.

Various architectures have been proposed for generating semantic embeddings of word groups: for instance, Skip-Thought (Kiros et al, 2015, in “Skip-Thought Vectors”, Advances in Neural Information Processing Systems 28, pages 3294-3302, ed. C. Cortes et al), InferSent (Conneau et al, 2017, in “Supervised Learning of Universal Sentence Representations from Natural Language Inference Data”, Proceedings of the 2017 Conference on Empirical Methods in natural Language processing, pages 670-680), Universal Sentence Encoder (Cer et al, “Universal Sentence Encoder”, arXiv: 1803:11175), and others. Such architectures may be used in embodiments of the invention. However, preferred implementations of encoder 32 employ an SBERT neural network architecture to generate the semantic embeddings of the ontologies.

The basic BERT architecture is an example of a transformer and was described by Jacob Devlin, et al, in “BERT: Pre-training of Deep Bidirectional Transformers for Language Understanding”, arXiv preprint arXiv: 1810.04805. In contrast to recurrent neural networks (RNNs), transformers employ attention mechanisms. BERT employs a siamese-twin neural network structure (in which the weights in parallel neural network structures are the same), having multiple layers, and it was designed to compare two sentences and yield an output indicative of the degree of similarity between them. To perform this sentence-pair regression task, a BERT network receives as input the two sentences for comparison, separated by a dedicated token [September], and applies multiple attention computer mechanisms for each neural network layer. SBERT modifies a BERT architecture so as to obtain an output which is a semantic embedding of an input word group. More particularly, SBERT starts with a trained BERT network, tunes it to a target task, and adds a pooling operation to the network's output so as to generate an output sentence embedding that has fixed size irrespective of the size of the input sentence.

So, in preferred implementations, the semantic embedding of an ontology ONTj is generated according to formula (1) below:

$${E}_{semantic}^{j} = SBERT ( {Ont}_{{text}_{information}}^{j} ) \qquad Formula ( 1 )$$

The composite-encoder implementation 30 illustrated in FIG. 3 includes an encoder 33, ENC_GR, which generates a graph embedding of the ontology ONTj. The graph-embedding approach is adopted so as to exploit information relevant to the ontologies (e.g., vertices) by projecting vertices into a latent space, where geometric relations in this latent space correspond to relationships (e.g., edges) in the original graph.

Suppose v∈V represents the vertex in the graph. The graph encoder implements a function that maps vertices to vector embeddings zᵥ∈R^{d} where zᵥ is the embedding of vertex v, recalling that R^{d} represents the real number space having d dimensions. The transformation accomplished by this function may be expressed according to formula (2) below.

$$ENC : v \to {R}^{d} \qquad Formula ( 2 )$$

A training process is used to generate, for a given dataset, a matrix Z∈R^{|v|×d} containing the embedding vectors for all vertices of the graph embodied in the dataset, recalling that R^{|v|×d} represents the real number space having dimension |v|×d. That is, each vertex v has an embedding vector, which is a real number vector with d dimensions, and for all vertices, a |v|*d matrix is built, e.g. the matrix Z. Given this matrix Z, any vertex v's embedding can be retrieved at any time, via an identifier v_{ID} of this vertex, by getting v_{ID}'s corresponding row from Z. The encoder takes vertex IDs as input to generate the vertex embeddings according to formula (3) below:

$${E}_{G R}^{v} = ENC ( v ) = Z [ v ] \qquad Formula ( 3 )$$

Where Z[v] denotes the row of Z corresponding to vertex v.

Various architectures have been proposed for graph neural networks (GNNs) suitable to generate graph embeddings of input objects, and embodiments of the invention may be constructed using any of these to implement the encoder 33. The known architectures include, amongst others:
architectures based on random walk models, e.g. Deepwalk described in “Deepwalk: Online learning of social representations”, by B. Perozzi, R. Al-Rfou, and S. Skiena, in Proceedings of the 20th ACM SIGKDD international conference on Knowledge discovery and data mining, 2014, pp. 701-710.
node2vec described in He et al op. cit.
LINE described in “Line: Large-scale information network embedding”, by J. Tang, M. Qu, M. Wang, M. Zhang, J. Yan, and Q. Mei, in Proceedings of the 24th international conference on world wide web, 2015, pp. 1067 {1077, and
struc2vec described in “struc2vec: Learning Node Representations from Structural Identity”, by Leonardo F. R. Ribeiro, Pedro H. P. Saverese and Daniel R. Figueiredo, in KDD '17: Proceedings of the 23rd ACM SIGKDD International Conference on Knowledge Discovery and Data Mining, August 2017, Pages 385-394.

Experiments have been conducted to evaluate the performance obtained when different ones of the above-mentioned four GNN architectures were used to perform graph embedding of digital-twin ontologies. The experiments were conducted on a graph embodied in the Thing'in platform. In the experiments, three kinds of vertices (ontologies: classes, data-properties and object-properties defined in Thing'in) and two kinds of edges (parent and child) were used to build the ontology graph, and in total there were 24062 vertices with 132046 edges to others.

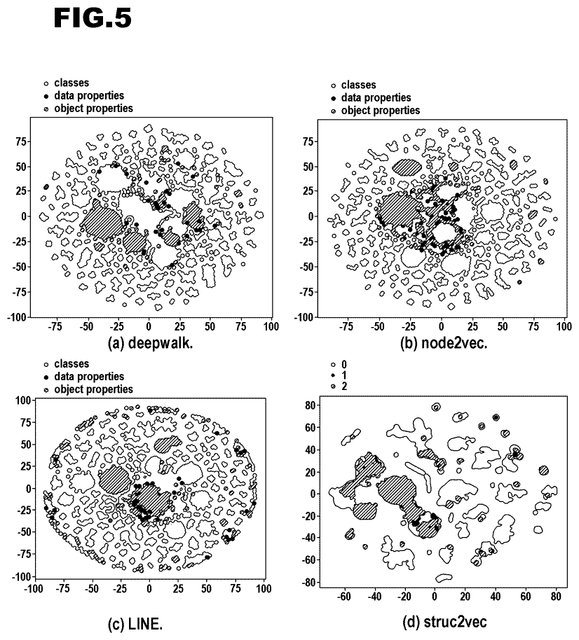

FIG. 5 provides a visual representation of the results of graph embedding performed by encoders having these different architectures. T-SNE (T-Stochastic Neighbor Embedding) is used to generate the images shown in FIG. 5, in which classes are represented in white, data-properties are represented in black, and object-properties are represented with hatching. It can be seen from FIG. 5 that better performance, in terms of grouping together similar vertices, is obtained by networks using the random walk model and node2vec model.

Another technique for evaluating the performance of the different graph-embedding architectures is to use them to perform a link-prediction task. The link prediction task is to predict whether there is an edge between two vertices in the graph. In our experiments, 80 percent of the available data was used for training and 20 percent for testing. Table 1 below shows the results of the link-prediction task when the embeddings of ontologies were performed using only graph embedding. Below, F1, acc and AUC are metrics which quantify training accuracy: the F1 score is the harmonic mean of precision and recall, acc is the accuracy (e.g. T/T+F), and AUC is the area under the Receiver Operating Characteristic (ROC) curve. If required, further information regarding these metrics may be found in “The relationship between precision-recall and ROC curves” by Jesse Davis and Mark Goadrich, in Proceedings of the 23^{rd} International Conference on Machine Learning, June 2006, pages 233-240, the entire contents of which are incorporated herein by reference.

TABLE 1

| Model used in graph- | | | |
|---|---|---|---|
| embedding | | | |
| architecture | F1 | acc | AUC |
| random walk | 0.9538 | 0.9538 | 0.9407 |
| node2vec | 0.9636 | 0.9636 | 0.9635 |
| LINE | 0.7969 | 0.7979 | 0.7954 |
| struc2vec | 0.6024 | 0.6024 | 0.6038 |

The experimental results in Table 1 show that, in the link-prediction task, the architectures based on the random walk and node2vec models perform better. That is because these two methods focus on the relevance between neighbor vertices, while the other two methods pay more attention to the overall structural similarity of the graph. And in the link-prediction task, the similarity between neighbor vertices is more important than structural similarity because this task aims to predict directly connected vertices.

The composite-encoder implementation 30 illustrated in FIG. 3, includes a concatenation module 34 which generates a composite embedding E^{j} in respect of an ontology ONTⱼ by concatenating the graph embedding E_{GR}^{j} generated for ontology ONTj by the encoder 32 with the semantic embedding E_{SEM}^{j} generated for ontology ONTj by the encoder 33. The concatenation function may be represented by Formula (4) below:

$${E}^{j} = concatenate ( [ {E}_{SEM}^{j} , {E}_{G R}^{j} ] ) \qquad Formula ( 4 )$$

Of course, if desired the order in which the graph embedding E_{GR}^{j} and semantic embedding E_{SEM}^{j} are concatenated may be reversed such that E_{GR}^{j} precedes E_{SEM}^{j}.

FIG. 4 illustrates a preferred embodiment 40 of the composite encoder ENC_COMP, in which the graph embedding E_{GR}^{j} is generated using a node2vec network 43 and the semantic embedding E_{SEM}^{j} is generated using an SBERT network 42, and the resulting embeddings are concatenated by a module 44 to generate the composite embedding E^{j} of ontology ONTⱼ.

Further experiments were performed to examine the effect on performance of combining the semantic embedding with the graph embedding of each ontology, in the case where the graph embedding was performed according to each of the random walk, node2vec, LINE and struc2vec GNNs discussed above. More particularly, the performance in the link-prediction task was evaluated. Table 2 below shows the results of these additional experiments.

TABLE 2

| Embedding technique | F1 | acc | AUC |
|---|---|---|---|
| Semantic + random | 0.8852 | 0.8852 | 0.8850 |
| walk | | | |
| Semantic + node2vec | 0.9184 | 0.9184 | 0.9182 |
| Semantic + LINE | 0.8533 | 0.8533 | 0.8522 |
| Semantic + struc2vec | 0.7280 | 0.7280 | 0.7252 |

The experimental results in Table 2 show that, in the link-prediction task, even in the case where the semantic embedding is combined with the graph embedding the GNN architectures based on the random walk and node2vec models perform better. It can be seen from a comparison of Table 2 with Table 1 that, in the link-prediction task, the performance of the GNN architectures based on the random walk and node2vec models is somewhat degraded in the case where the semantic embedding is combined with the graph embedding. However, for the purposes of predicting the next ontology that follows on from a sequence based on user input, it is preferred to use composite embeddings that include the semantic embedding as well as the graph embedding so that there is increased diversity in the results output to the user. Thus, preferred embodiments of the invention employ composite embeddings that combine a semantic embedding with a graph embedding, and generate the graph embedding using a GNN based on the node2vec model.

Returning to the overall system 1 illustrated in FIG. 2, consideration is now given to the implementation of the module 16 which generates the characteristic embedding Eᵤₛₑᵣ for the overall sequence, based on the composite embeddings of the ontologies in that sequence.

When seeking to predict the next ontology in the sequence corresponding to the user's input, it could be contemplated to make use of a neural network architecture which is trained using a supervised learning approach. However, in many applications suitable training data is unavailable, i.e., there is no (or insufficient) historical information available regarding past sequences of ontologies involved in user input to the digital-twin platform in question.

In contrast, therefore, in embodiments of the present invention a representative embedding is generated to characterize the overall sequence of the user's current input. More precisely, a representative embedding Eᵤₛₑᵣ is generated from the composite embeddings of the sequence of ontologies under consideration.

Preferred embodiments of the invention calculate exponentially weighted averages to memorize the sequence of user input and let the latest input ontology have a greater weight in the representative embedding than the ontologies input longer ago.

Certain embodiments of the invention use a first method, called a momentum method, to generate the representative embedding from the composite embeddings of the sequence of ontologies under consideration. According to this momentum method, the representative embedding E_{user,n} characterizing an overall sequence of length n is determined according to Formula (5) below:

$${E}_{user , n} = \{ \begin{matrix}{E}^{n} , & n = 0 \\ β * {E}_{user , n - 1} + ( 1 - β ) * {E}^{n} , & n > 0\end{matrix} \qquad Formula ( 5 )$$

where β is the momentum coefficient which ranges from 0 to 1.

Certain other embodiments of the invention use a second method in which different weights are used for different ontologies according to Formula (6) below:

$${W}_{t} = \{ \begin{matrix}α , & t = 0 \\ β , & t = 1 \\ α * {W}_{t - 2} + β * {W}_{t - 1} , & t > 1\end{matrix} \qquad Formula ( 6 )$$

where Wt represents the weight for ONTₜ, and α and β are pre-set coefficients (which may be adjusted according to the final degree of prediction recalling the user's input history). In one example implementation, good results were obtained using the values α=0.7 and β=0.5. Then the representative embedding Eᵤₛₑᵣ for the overall sequence is generated according to Formula (7) below:

$${E}_{user , n} = {\sum }_{t = 0}^{n} {W}_{t} * {E}^{t} \qquad Formula ( 7 )$$

When B is determined: the weight, within Eᵤₛₑᵣ obtained by the first method, of the latest ontology in the sequence is determined and is not related to the sequence length. However, the weight of the ontologies in Eᵤₛₑᵣ obtained by the second method is related to the sequence length: the longer the sequence, the greater the weight of the latest ontology. Therefore, in applications where it is desired to be more focused on the latest user input it is preferable to determine the representative embedding Eᵤₛₑᵣ by the second method and, on the contrary, where it is desired to have more balance over the whole input history it is preferable to determine the representative embedding Eᵤₛₑᵣ according to the first method.

Returning yet again to the overall system 1 illustrated in FIG. 2, consideration is now given to the implementation of the comparison module 18 which evaluates the degree of similarity between the representative embedding Eᵤₛₑᵣ and composite embeddings of one or more candidate ontologies. Typically the candidate ontologies are all the ontologies defined in the dataset and constituting vertices in the graph modelled by the graph neural network. However, if desired, a sub-set of the ontologies defined in the dataset may be considered as candidate ontologies. The composite embedding of a candidate ontology may be generated in the same manner as the composite embeddings are generated in respect of the ontologies in the user-input sequence and, thus, it combines a graph embedding and a semantic embedding of the candidate ontology. The set of candidate-ontology composite-embeddings that are compared to the representative embedding Eᵤₛₑᵣ may be denoted {E_{CAND}ⁱ}.

It will readily be appreciated that various different techniques can be used to evaluate the similarity between the representative embedding Eᵤₛₑᵣ characterizing the user input sequence and each of the composite embeddings in {E_{CAND}ⁱ}. In preferred embodiments of the invention cosine similarity is evaluated and the candidate ontologies are then ordered by their degree of cosine similarity to Eᵤₛₑᵣ. For the representative embedding Eᵤₛₑᵣ characterizing the sequence, and candidate ontology embedding E_{CAND}ⁱ, the cosine similarity may be calculated according to Formula (8) below:

$$Cos Sim ( {E}_{user} , {E}_{CAND}^{i} ) = \frac{{E}_{user} \times {E}_{CAND}^{i}}{‖ {E}_{user} ‖ \times ‖ {E}_{CAND}^{i} ‖} \qquad Formula ( 8 )$$

The candidate ontologies may be sorted from high to low, according to the cosine similarity between the input sequence and the respective candidate ontology. A selected number of the candidate ontologies is then output to the user, for example the K top results.

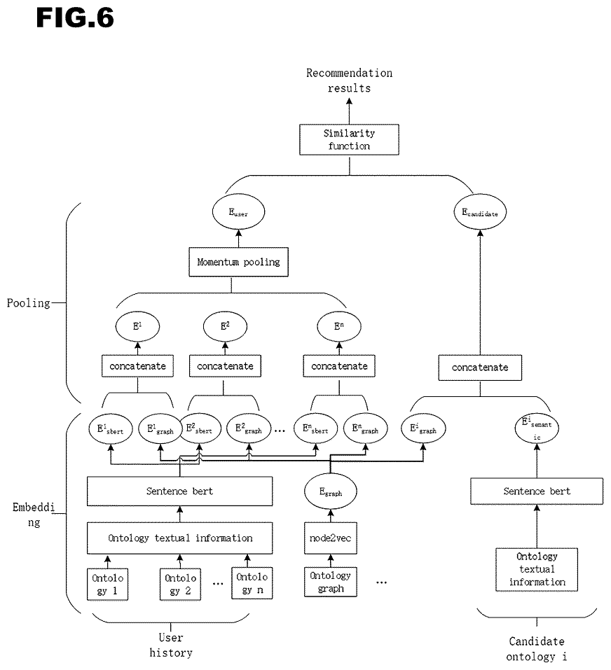

FIG. 6 is a schematic representation of a preferred embodiment of the overall system to predict the next ontology following on from a sequence corresponding to user input (called user history in FIG. 6). Although FIG. 6 shows two SBERT networks, one generating a semantic embedding for the ontologies in the input sequence and the other generating semantic embeddings for candidate ontologies defined within the targeted dataset, it is to be understood that semantic embeddings of all of these ontologies may be generated using a common SBERT network. Furthermore, although the composite embeddings of the candidate ontologies may be generated on the fly, at the time when the system seeks to predict what will be the next ontology in the sequence corresponding to the user input, time delays at that moment can be avoided in the case where the composite embeddings of ontologies defined in the target dataset have already been generated ahead of time. In particular, a preliminary step may be performed, before the user input sequence is received, to generate composite embeddings of all, or a selected set of, the ontologies defined in the target dataset. In general, platforms on which digital twins are defined/registered are dynamic and over time there are changes in the graph defining the ontologies and the relationships between them. Thus, it is preferable to periodically re-run the training of the graph neural graph network so as to ensure that the GNN models the up-to-date state of the graph.

### VARIANTS

Although the present invention has been described above with reference to certain specific embodiments, it will be understood that the invention is not limited by the particularities of the specific embodiments but, to the contrary, that numerous variations, modifications and developments may be made in the above-described embodiments within the scope of the appended claims.

For example, although the specific embodiments described above relate to IoT platforms, corresponding techniques may be applied to search in other domains.

Incidentally, the specific embodiments described above focus on the processing of sequences of ontologies corresponding to input by a human user. However, the sequence of ontologies could be generated by a non-human agent (e.g., a bot), for example, upon detection that a trigger condition has been met.

1. A computer-implemented method comprising:
predicting for a user, from a sequence of digital-twin ontologies corresponding to input by the user to a computerized platform, a next digital-twin ontology following said sequence, the predicting comprising:
generating a composite embedding of each of the digital-twin ontologies in said sequence, wherein the composite embedding combines a semantic embedding and a graph embedding of said digital-twin ontology;
determining, for said sequence of digital twin ontologies, a representative embedding characterizing the composite embeddings of the ontologies of the sequence;
comparing the representative embedding of the sequence with respective composite embeddings of each of a plurality of candidate ontologies defined on said computerized platform, to determine a degree of similarity between the representative embedding of the sequence and each of the composite embeddings of the candidate ontologies; and
outputting, to the user, as a prediction of the next digital-twin ontology following on from said sequence, information identifying a selected one or more of the candidate ontologies determined, by the comparing, to have a composite embedding similar to the representative embedding of the sequence.

2. The computer-implemented method according to claim 1, wherein the determining of the representative embedding for the sequence of digital-twin ontologies comprises determining an exponential weighted average of the composite embeddings of the ontologies of the sequence.

3. The computer-implemented method according to claim 2, wherein the exponential weighted average of the composite embeddings of the ontologies of the sequence is determined according to the following formula:
$${( {E}_{user} )}_{n} = \{ \begin{matrix}{E}^{n} , & n = 0 \\ β * {( {E}_{user} )}_{n - 1} + ( 1 - β ) * {E}^{n} , & n > 0\end{matrix}$$
where (Eᵤₛₑᵣ)ₙ is the representative embedding determined for a sequence of n ontologies, Eⁿ is the composite embedding of the ontology ONTn in the sequence, and β is a momentum coefficient which ranges from 0 to 1.

4. The computer-implemented method according to claim 2, wherein the exponential weighted average of the composite embeddings of the ontologies of the sequence is determined according to the following formula:
$${( {E}_{user} )}_{n} = {\sum }_{t = 0}^{n} {W}_{t} * {E}^{t}$$
where (Eᵤₛₑᵣ)ₙ is the representative embedding determined for a sequence of n ontologies, E^{t} is the composite embedding of the ontology ONTₜ in the sequence, and Wₜ is a weight applied to the composite embedding of the ontology ONTₜ, said weights being determined according to the formula:
$${W}_{t} = \{ \begin{matrix}α , & t = 0 \\ β , & t = 1 \\ α * {W}_{t - 2} + β * {W}_{t - 1} , & t > 1\end{matrix}$$
where α and β are pre-set coefficients.

5. The computer-implemented method according to claim 1, wherein the generating of a composite embedding of an ontology comprises concatenating said semantic embedding and said graph embedding of the ontology.

6. The computer-implemented method according to claim 1, wherein the generating of a composite embedding of an ontology comprises generating a graph embedding of the ontology using a graph neural network implementing a node2vec model.

7. The computer-implemented method according to claim 1, wherein the generating of a composite embedding of an ontology comprises using an SBERT (Sentence-Bidirectional encoder representations from transformers) network to generate a semantic embedding of textual information characterizing the ontology.

8. The computer-implemented method according to claim 1, comprising assigning a rank score to said candidate ontologies based on the similarity of their composite embeddings to the representative embedding of the sequence, and selecting for outputting one or more of the ontologies having the highest rank score.

9. The computer-implemented method according to claim 1, and comprising determining said sequence of ontologies from a sequence of digital twins identified by the user input.

10. The computer-implemented method according to claim 1, and comprising automatically creating, on the computerized platform, a digital twin instantiating a candidate ontology selected to be identified in the outputting.

11. A recommendation system comprising:
a computing apparatus programmed to execute instructions to perform a method of predicting for a user, from a sequence of digital-twin ontologies corresponding to input by the user to a computerized platform, a next digital-twin ontology following said sequence, the method comprising:
generating a composite embedding of each of the digital-twin ontologies in said sequence, wherein the composite embedding combines a semantic embedding and a graph embedding of said digital-twin ontology;
determining, for said sequence of digital twin ontologies, a representative embedding characterizing the composite embeddings of the ontologies of the sequence;
comparing the representative embedding of the sequence with respective composite embeddings of each of a plurality of candidate ontologies defined on said computerized platform, to determine a degree of similarity between the representative embedding of the sequence and each of the composite embeddings of the candidate ontologies; and
outputting, to the user, as a prediction of the next digital-twin ontology following on from said sequence, information identifying a selected one or more of the candidate ontologies determined, by the comparing, to have a composite embedding similar to the representative embedding of the sequence.

12. (canceled)

13. A non-transitory computer-readable medium comprising instructions which, when executed by a processor of a computing apparatus, cause the processor to perform a method of predicting for a user, from a sequence of digital-twin ontologies corresponding to input by the user to a computerized platform, a next digital-twin ontology following said sequence, the method comprising:
generating a composite embedding of each of the digital-twin ontologies in said sequence, wherein the composite embedding combines a semantic embedding and a graph embedding of said digital-twin ontology;
determining, for said sequence of digital twin ontologies, a representative embedding characterizing the composite embeddings of the ontologies of the sequence;
comparing the representative embedding of the sequence with respective composite embeddings of each of a plurality of candidate ontologies defined on said computerized platform, to determine a degree of similarity between the representative embedding of the sequence and each of the composite embeddings of the candidate ontologies; and
outputting, to the user, as a prediction of the next digital-twin ontology following on from said sequence, information identifying a selected one or more of the candidate ontologies determined, by the comparing, to have a composite embedding similar to the representative embedding of the sequence.

14. The computer-implemented method according to claim 1, and further comprising:
automatically generating a digital twin instantiating the next ontology that follows on from the sequence corresponding to user input.

15. The computer-implemented method according to claim 1, and further comprising automatically generating a search query including, as a search term, the next ontology that follows on from the sequence corresponding to user input.
